(19) United States
(12) Patent Application Publication
(10) Pub. No.: US 2010/0280424 A1
(43) Pub. Date: Nov. 4, 2010

(54) MUSCLE FORCE ASSISTING DEVICE

(75) Inventors: Takashi Kawakami, Ehime (JP); Toshihiko Ishiko, Ehime (JP); Keisuke Ueda, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/810,611

(22) PCT Filed: Mar. 10, 2009
(86) PCT No.: PCT/JP2009/001051

§ 371 Date: Jun. 25, 2010

(30) Foreign Application Priority Data
Mar. 27, 2008 (JP) 2008-084677
Sep. 11, 2008 (JP) 2008-233929

(51) Int. Cl. A61H 1/02

(52) U.S. Cl. 601/33

(57) ABSTRACT

A muscle force assisting device includes a first attachment arranged along one bone of a joint, a second attachment arranged along the other bone of the joint, and a stretching-artificial muscle having one end provided on the first attachment and having the other end provided on the second attachment, in which an actuator that is extensible by supplying or discharging a substance such as gas, liquid and solid, or a mixture thereof is used as the stretching-artificial muscle, the muscle force assisting device assists motion of a user's joint such as an elbow, a knee and a wrist, a protecting member is provided on the first attachment as a path-restricting section that restricts a path of the stretching-artificial muscle, the protecting member restricts approach of the stretching-artificial muscle toward the joint, the stretching-artificial muscle is prevented from pressing a human body even if the path of the artificial muscle is changed by bending or stretching motion, and the a driving force of the artificial muscle can efficiently be converted into a stretching torque.

### TECHNICAL FIELD

The present invention relates to a muscle force assisting device that assists motion of a user's joint such as an elbow, a knee, and a wrist using an actuator that is extensible by supplying or discharging a substance such as gas, liquid and solid, or a mixture thereof.

### BACKGROUND TECHNIQUE

There has already been proposed a power device including a tube that is characterized in that if a substance such as gas, liquid and solid, or a mixture thereof is infused into the tube, a size thereof in its longitudinal direction is restrained but it expands in its radial direction, a cylindrical sleeve that is extensible in its longitudinal direction and radial direction is disposed outside the tube, both ends of the tube are restrained, an inlet is formed in one of the ends, and a film or fiber made of polyester-based, polyamide-based, polyethylene-based, polyimide-based, polystyrene-based, polycarbonate-based substance or mixture thereof is used as the tube (patent document 1).

Further, the present assignee has already proposed a muscle force assisting device utilizing this kind of power device (patent document 2).

The muscle force assisting device proposed in the patent documents is shown in FIGS. 13 to 15.

FIG. 13 is a perspective view of essential portions showing a stretched extended state of the conventional muscle force assisting device. FIG. 14 is a perspective view of essential portions showing a bent state of the muscle force assisting device. FIG. 15 is a perspective view of essential portions showing a state where an artificial muscle is stretched without a load in the muscle force assisting device.

The muscle force assisting device includes a first attachment 10 arranged along one bone of a joint, a second attachment 20 arranged along the other bone of the joint, and an artificial muscle 30 having one end 31 provided on the first attachment 10, and having the other end 32 provided on the second attachment 20. The first attachment 10 is attached to an upper arm, and the second attachment 20 is attached to a forearm.

The artificial muscle 30 is an actuator that is extensible at least in its longitudinal direction by supplying or discharging a substance such as gas, liquid and solid, or a mixture thereof.

The first attachment 10 has a swing arm 40. An end of the swing arm 40 opposite from the joint is a turning fulcrum 41, and an end of the swing arm 40 on the side of the joint is a displacing end. The one end 31 of the artificial muscle 30 is provided on the displacing end of the swing arm 40.

The first attachment 10 includes an auxiliary artificial muscle 50. One end 51 of the auxiliary artificial muscle 50 is provided on an end of the first attachment 10 opposite from the joint, and the other end 52 of the auxiliary artificial muscle 50 is provided on the displacing end of the swing arm 40.

The first attachment 10 includes a guide plate 60. The guide plate 60 includes a guide hole 61, and the displacing end of the swing arm 40 is displaced along the guide hole 61.

The first attachment 10 and the second attachment 20 are connected to each other through spring joints 70.

The muscle force assisting device includes a stretching-artificial muscle 80 on the side of the elbow. FIG. 14 shows a state where the stretching-artificial muscle 80 is most stretched, and FIG. 13 shows a state where the artificial muscle is most contracted.

As described above, according to the conventional muscle force assisting device, the first attachment 10 and the second attachment 20 are connected to each other through the spring joints 70, and coil springs are used as the spring joints 70.

With this configuration, even if the muscle force assisting device and the joint are deviated from each other, smooth motion can be secured.

[Patent Document 1] Japanese Patent Application Laid-open No.2004-105263

[Patent Document 2] Japanese Patent Application Laid-open No.2007-340673

### DISCLOSURE OF THE INVENTION

However, when the stretching-artificial muscle 80 is bent as shown in FIG. 14, the artificial muscle 80 approaches the elbow and presses the user in some cases.

Further, when the stretching-artificial muscle 80 is bent as shown in FIG. 14, a driving force does not efficiently generate a torque at the time of its stretching motion depending upon a bent manner of the stretching-artificial muscle 80 in some cases.

Further, when the stretching-artificial muscle 80 is bent as shown in FIG. 14, no load is applied to the stretching-artificial muscle 80, but the stretching-artificial muscle 80 may be bent unnaturally or mechanical friction may be generated between the artificial muscle and other member, and unnecessary restricting force may be generated in some cases.

On the other hand, if the stretching-artificial muscle 80 is stretched without a load without driving the stretching-artificial muscle 80 as shown in FIG. 15, since the stretching-artificial muscle 80 keeps maintaining its natural length, the artificial muscle sags. Such a sag may cause interference between the stretching-artificial muscle 80 and other member, or the artificial muscle may be damaged by stress concentration generated by bending of the stretching-artificial muscle 80.

Hence, it is an object of the present invention to provide a muscle force assisting device capable of preventing the artificial muscle from pressing a human body or from unnecessarily sagging even if a path of the artificial muscle is changed due to the bending or stretching motion, and capable of efficiently converting a driving force of the artificial muscle into a stretching torque.

It is another object of the invention to provide a muscle force assisting device capable of preventing unnecessary restricting force from being generated when no load is applied to the artificial muscle.

### MEANS FOR SOLVING THE PROBLEM

A first aspect of the present invention provides a muscle force assisting device comprising a first attachment arranged along one bone of a joint, a second attachment arranged along the other bone of the joint, and an artificial muscle having one end provided on the first attachment and having the other end provided on the second attachment, in which an actuator that is extensible by supplying or discharging a substance such as gas, liquid and solid, or a mixture thereof is used as the artificial muscle, and the muscle force assisting device assists motion of a user's joint such as an elbow, a knee and a wrist, wherein a path-restricting section that restricts a path of the artificial muscle is provided on the first attachment or the second attachment.

According to a second aspect of the invention, in the muscle force assisting device of the first aspect, the path-restricting section is provided on the first attachment, and the path-restricting section restricts approach of the artificial muscle toward the joint.

According to a third aspect of the invention, in the muscle force assisting device of the second aspect, the path-restricting section is provided on the first attachment such that the path-restricting section can turn.

According to a fourth aspect of the invention, in the muscle force assisting device of the second aspect, the path-restricting section includes a supporting member mounted on the first attachment, and a holding member that holds the artificial muscle, a pin hole of the supporting member and a pin hole of the holding member are connected to each other through a connection pin, and the pin hole of one of the supporting member or the holding member is a long hole.

According to a fifth aspect of the invention, in the muscle force assisting device of the second aspect, the path-restricting section includes a supporting member mounted on the first attachment, and a holding member that holds the artificial muscle, and the supporting member and the holding member can slide in a longitudinal direction of the artificial muscle.

According to a sixth aspect of the invention, in the muscle force assisting device of the fourth or fifth aspect, the supporting member includes a one-side supporting piece provided on one side of the first attachment, and an other-side supporting piece provided on the other side of the first attachment.

According to a seventh aspect of the invention, in the muscle force assisting device of the sixth aspect, the two artificial muscles are arranged in parallel to each other, the holding member includes a one-artificial muscle holding piece that holds one artificial muscle and an other-artificial muscle holding piece that holds the other artificial muscle, the one-artificial muscle holding piece is provided on the one-side supporting piece, and the other-artificial muscle holding piece is provided on the other-side supporting piece.

According to an eighth aspect of the invention, in the muscle force assisting device of the seventh aspect, the first attachment is separated into a one-side first attachment and an other-side first attachment, the second attachment is separated into a one-side second attachment and an other-side second attachment, and the one-artificial muscle holding piece and the other-artificial muscle holding piece are separated from each other.

According to a ninth aspect of the invention, in the muscle force assisting device of the second aspect, the other end of the artificial muscle is provided on the second attachment through a guide mechanism, and the other end of the artificial muscle moves along the guide mechanism.

According to a tenth aspect of the invention, in the muscle force assisting device of the ninth aspect, the other end of the artificial muscle is biased by an elastic member in a stretching direction of the artificial muscle.

According to an eleventh aspect of the invention, in the muscle force assisting device of the second aspect, the first attachment is attached to an upper arm, the second attachment is attached to a forearm, and the artificial muscle is located outside of the elbow.

According to a twelfth aspect of the invention, in the muscle force assisting device of the first aspect, a guide is provided on the second attachment along the other bone, and the path-restricting section is provided on an end of the guide on the side of the joint.

According to a third aspect of the invention, in the muscle force assisting device of the twelfth aspect, a straight line connecting a terminal end of the path-restricting section and a fixed end of the first attachment of the artificial muscle is always located outside of the joint.

According to a fourth aspect of the invention, in the muscle force assisting device of the twelfth aspect, the other end of the artificial muscle is provided on the guide such that the other end can slide.

According to a fifth aspect of the invention, the muscle force assisting device of the twelfth aspect further comprises a tension-giving member that pulls the other end of the artificial muscle toward the one end thereof.

According to a sixteenth aspect of the invention, in the muscle force assisting device of the fifteenth aspect, a wire is provided as the tension-giving member, one end of the wire is mounted on the other end of the artificial muscle, and the other end of the wire is mounted on the first attachment.

According to a seventeenth aspect of the invention, in the muscle force assisting device of the sixteenth aspect, a path of the wire is restricted by the path-restricting section.

According to an eighteenth aspect of the invention, in the muscle force assisting device of the twelfth aspect, the first attachment is attached to an upper arm, the second attachment is attached to a forearm, and the artificial muscle is located outside of the elbow.

### EFFECT OF THE INVENTION

According to the present invention, even if a path of the artificial muscle is changed due to the bending or stretching motion, it is possible to prevent the artificial muscle from pressing a human body. It is also possible to efficiently convert a driving force of the artificial muscle into a stretching torque. It is also possible to prevent unnecessary restricting force from being generated when no load is applied to the artificial muscle. It is also possible to prevent the artificial muscle from sagging and from interfering with another member and from being damaged by the interference.

### BRIEF DESCRIPTION OF THE DRAWINGS

FIG. 1 is a side view showing bent and stretched states of a muscle force assisting device according to an embodiment;

FIG. 2 is a perspective view of the muscle force assisting device;

FIG. 3 is a perspective view of the muscle force assisting device as viewed from another direction;

FIG. 4 is a perspective view of a protecting member used for the muscle force assisting device;

FIG. 5 is a perspective view of the protecting member of the embodiment as viewed from another direction;

FIG. 6 is a front view of the protecting member;

FIG. 7 is a perspective view showing a stretched state of a protecting member according to another embodiment of the invention;

FIG. 8 is a perspective view showing a bent state of the protecting member;

FIG. 9 is a side view of a protecting member according to another embodiment of the invention;

FIG. 10 is a side view of a protecting member according to another embodiment of the invention;

FIG. 11 is a side view showing a stretched state of a muscle force assisting device according to another embodiment of the invention;

FIG. 12 is a side view showing a bent state of the muscle force assisting device;

FIG. 13 is a perspective view of essential portions showing a stretched state of a conventional muscle force assisting device;

FIG. 14 is a perspective view of the essential portions showing a bent state of the conventional muscle force assisting device; and

FIG. 15 is a perspective view of essential portions showing a state where an artificial muscle is stretched without a load in the muscle force assisting device.

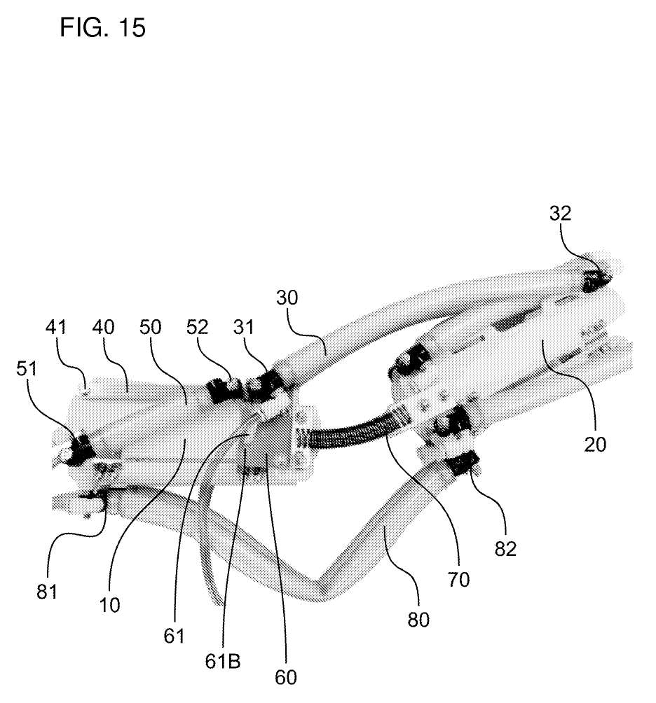

### BEST MODE FOR CARRYING OUT THE INVENTION

In the muscle force assisting device of the first aspect of the invention, the first attachment or the second attachment includes the path-restricting section that restricts the path of the artificial muscle. According to the first aspect, it is possible to prevent the path of the artificial muscle from being changed unintentionally.

According to the second aspect of the invention, in the muscle force assisting device of the first aspect, the path-restricting section is provided on the first attachment, and the path-restricting section restricts approach of the artificial muscle toward the joint. With this aspect, even if the path of the stretching-artificial muscle is changed by the bending or stretching motion, it is possible to prevent the artificial muscle from pressing a human body, and to efficiently convert a driving force of the stretching-artificial muscle into a stretching torque.

According to the third aspect of the invention, in the muscle force assisting device of the second aspect, the path-restricting section is provided on the first attachment such that the path-restricting section can turn. With this aspect, it is possible to prevent the change of the path of the artificial muscle from being excessively restricted.

According to the fourth aspect of the invention, in the muscle force assisting device of the second aspect, the path-restricting section includes a supporting member mounted on the first attachment, and a holding member that holds the artificial muscle, a pin hole of the supporting member and a pin hole of the holding member are connected to each other through a connection pin, and the pin hole of one of the supporting member or the holding member is a long hole. With this aspect, the long hole can moderate a load generated by a difference of a physical type of a user or by an attaching deviation, and it is possible to prevent the path-restricting section from being damaged.

According to the fifth aspect of the invention, in the muscle force assisting device of the second aspect, the path-restricting section includes a supporting member mounted on the first attachment, and a holding member that holds the artificial muscle, and the supporting member and the holding member can slide in a longitudinal direction of the artificial muscle. With this aspect, it is possible to moderate a rub generated between the path-restricting section and the artificial muscle by stretch and contraction of the artificial muscle.

According to the sixth aspect of the invention, in the muscle force assisting device of the fourth or fifth aspect, the supporting member includes a one-side supporting piece provided on one side of the first attachment, and an other-side supporting piece provided on the other side of the first attachment. With this aspect, since the supporting member can be supported from both sides of the attachment, stable motion can be secured.

According to the seventh aspect of the invention, in the muscle force assisting device of the sixth aspect, the two artificial muscles are in parallel to each other, the holding member includes a one-artificial muscle holding piece that holds one artificial muscle and an other-artificial muscle holding piece that holds the other artificial muscle, the one-artificial muscle holding piece is provided on the one-side supporting piece, and the other-artificial muscle holding piece is provided on the other-side supporting piece. With this aspect, the two artificial muscles can stably move, and bending and stretching motion having small torsion can be carried out by the two parallel artificial muscles.

According to the eighth aspect of the invention, in the muscle force assisting device of the seventh aspect, the first attachment is separated into a one-side first attachment and an other-side first attachment, the second attachment is separated into a one-side second attachment and an other-side second attachment, and the one-artificial muscle holding piece and the other-artificial muscle holding piece are separated from each other. With this aspect, since the attachment can be separated into the one side and the other side, a user can easily wear the artificial muscle.

According to the ninth aspect of the invention, in the muscle force assisting device of the second aspect, the other end of the artificial muscle is provided on the second attachment through a guide mechanism, and the other end of the artificial muscle moves along the guide mechanism. With this aspect, it is possible to prevent an unnecessary restricting force from being generated when no load is applied to the artificial muscle.

According to the tenth aspect of the invention, in the muscle force assisting device of the ninth aspect, the other end of the artificial muscle is biased by an elastic member in a stretching direction of the artificial muscle. With this aspect, it is possible to prevent mechanical friction from generating an unnecessary restricting force when no load is applied to the artificial muscle.

According to the eleventh aspect of the invention, in the muscle force assisting device of the second aspect, the first attachment is attached to an upper arm, the second attachment is attached to a forearm, and the artificial muscle is located outside of the elbow. With this aspect, it is possible to avoid a case where the artificial muscle presses the elbow by the bending motion of the elbow.

According to the twelfth aspect of the invention, in the muscle force assisting device of the first aspect, a guide is provided on the second attachment along the other bone, and the path-restricting section is provided on an end of the guide on the side of the joint. With this aspect, it is possible to prevent the artificial muscle from pressing a human body even if the path of the artificial muscle is changed by the bending or stretching motion, and it is possible to efficiently convert a driving force of the artificial muscle into a stretching torque.

According to the thirteenth aspect of the invention, in the muscle force assisting device of the twelfth aspect, a straight line connecting a terminal end of the path-restricting section and a fixed end of the first attachment of the artificial muscle is always located outside of the joint. With this aspect, the elbow is not pressed, and the driving force can be converted into an effective torque.

According to the fourteenth aspect of the invention, in the muscle force assisting device of the twelfth aspect, the other end of the artificial muscle is provided on the guide such that the other end can slide. With this aspect, a sag can be prevented by sliding the other end of the artificial muscle.

According to the fifteenth aspect of the invention, the muscle force assisting device of the twelfth aspect further comprises a tension-giving member that pulls the other end of the artificial muscle toward the one end thereof. With this aspect, the free end of the artificial muscle is pulled toward the joint when bending motion, and this avoids a case where the artificial muscle is caught on a plate or the guide and the bending motion is hindered.

According to the sixteenth aspect of the invention, in the muscle force assisting device of the fifteenth aspect, a wire is provided as the tension-giving member, one end of the wire is mounted on the other end of the artificial muscle, and the other end of the wire is mounted on the first attachment. With this aspect, the artificial muscle is pulled by the wire from the first attachment, and it is possible to reliably slide the free end of the artificial muscle.

According to the seventeenth aspect of the invention, in the muscle force assisting device of the sixteenth aspect, a path of the wire is restricted by the path-restricting section. With this aspect, it is possible to secure stable motion of the wire.

According to the eighteenth aspect of the invention, in the muscle force assisting device of the twelfth aspect, the first attachment is attached to an upper arm, the second attachment is attached to a forearm, and the artificial muscle is located outside of the elbow. With this aspect, it is possible to avoid a case where the artificial muscle presses the elbow by the bending motion of the elbow.

### EMBODIMENTS

An embodiment of the muscle force assisting device of the present invention will be described below.

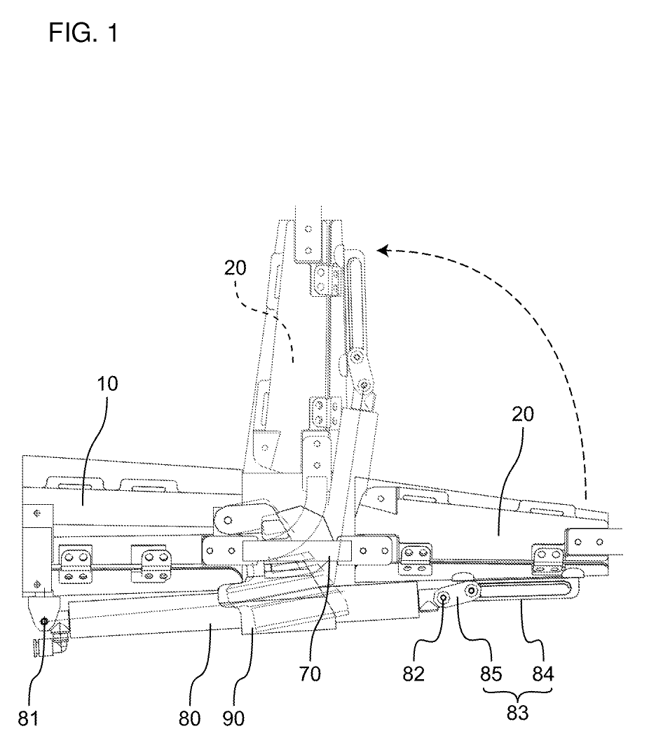

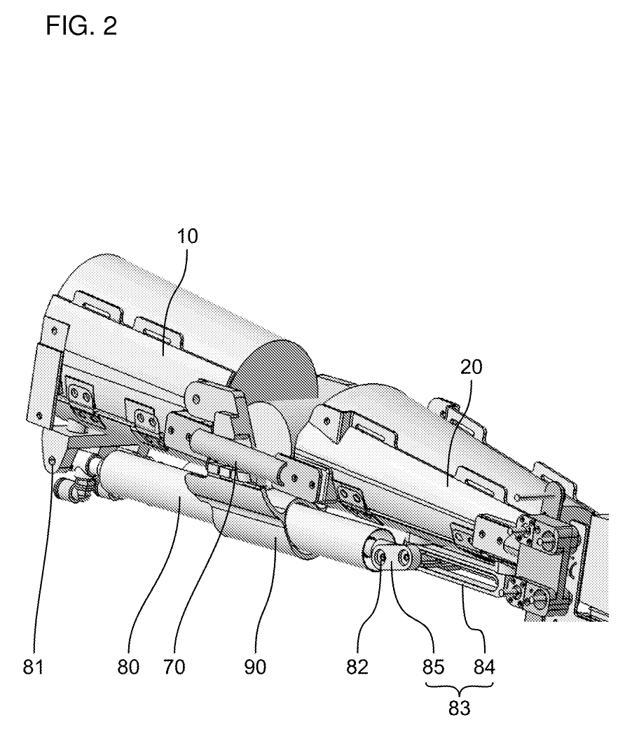

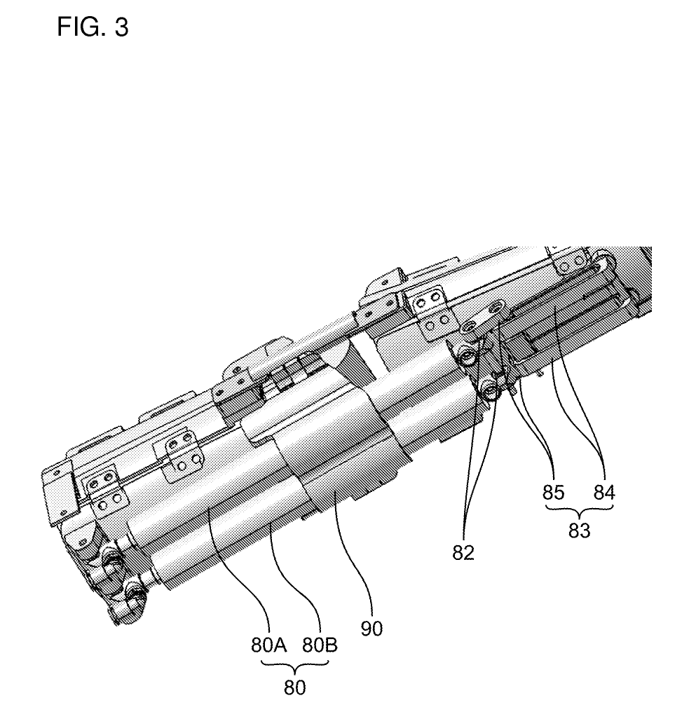

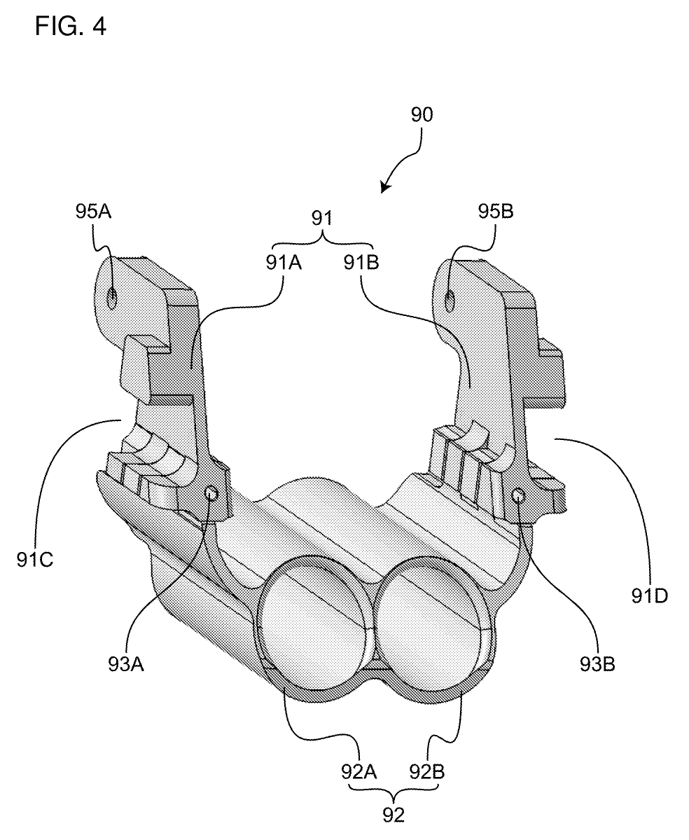

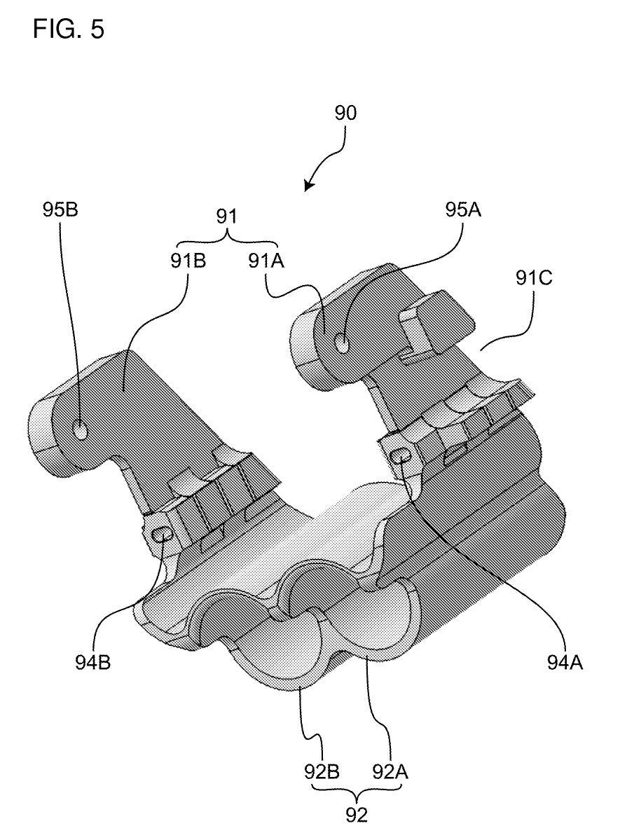

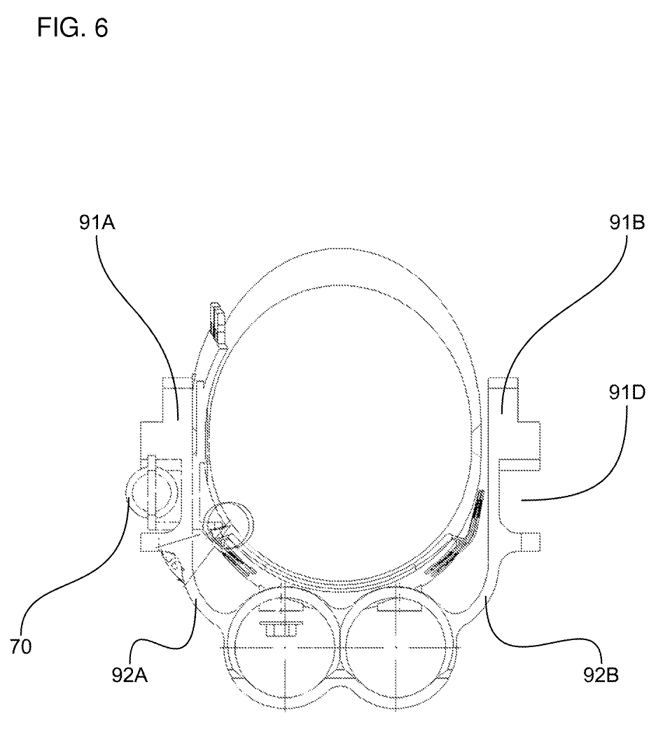

FIG. 1 is a side view showing bent and stretched states of a muscle force assisting device according to the embodiment. FIG. 2 is a perspective view of the muscle force assisting device. FIG. 3 is a perspective view of the muscle force assisting device as viewed from another direction. FIG. 4 is a perspective view of a protecting member used for the muscle force assisting device. FIG. 5 is a perspective view of the protecting member of the embodiment as viewed from another direction. FIG. 6 is a front view of the protecting member.

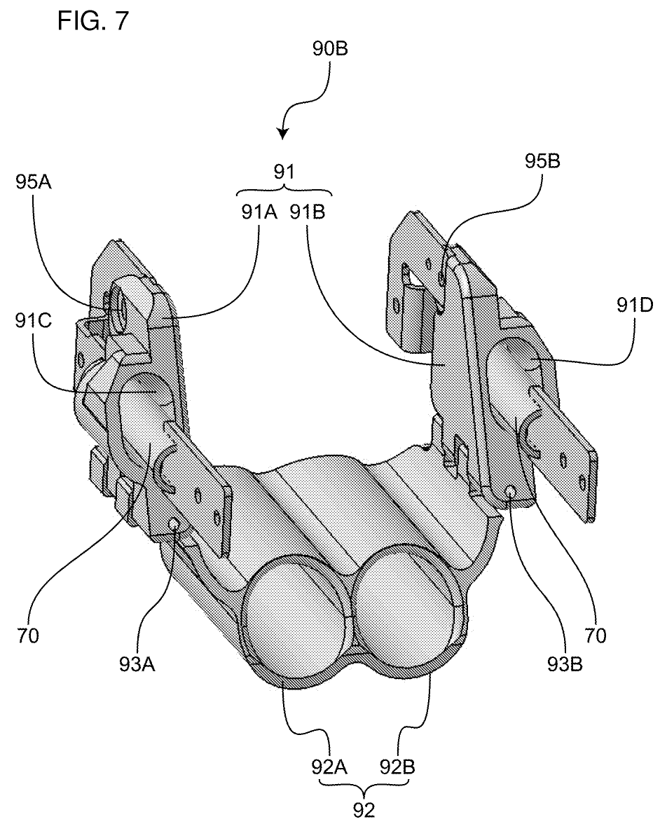

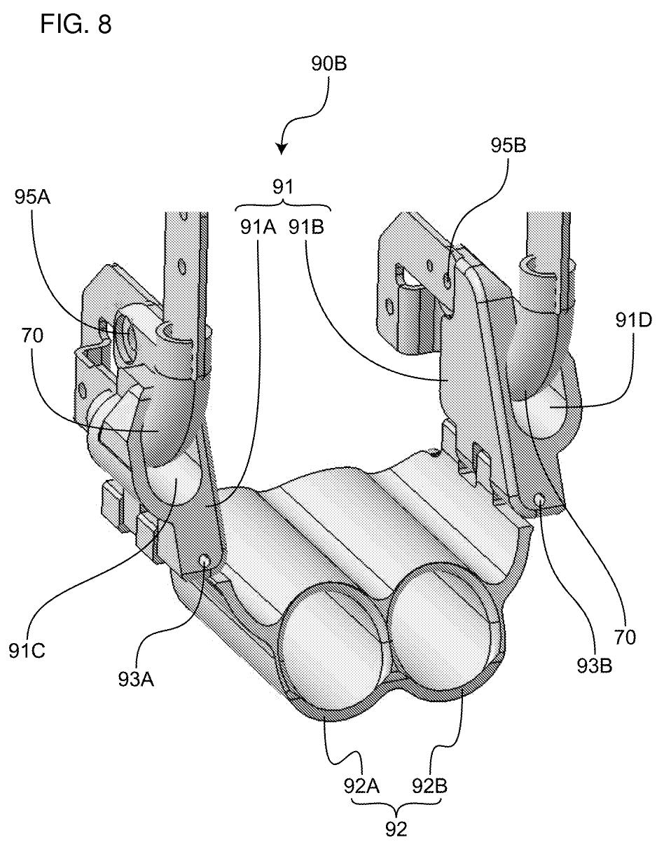

FIG. 7 is a perspective view showing a stretched state of a protecting member according to another embodiment of the invention. FIG. 8 is a perspective view showing a bent state of the protecting member.

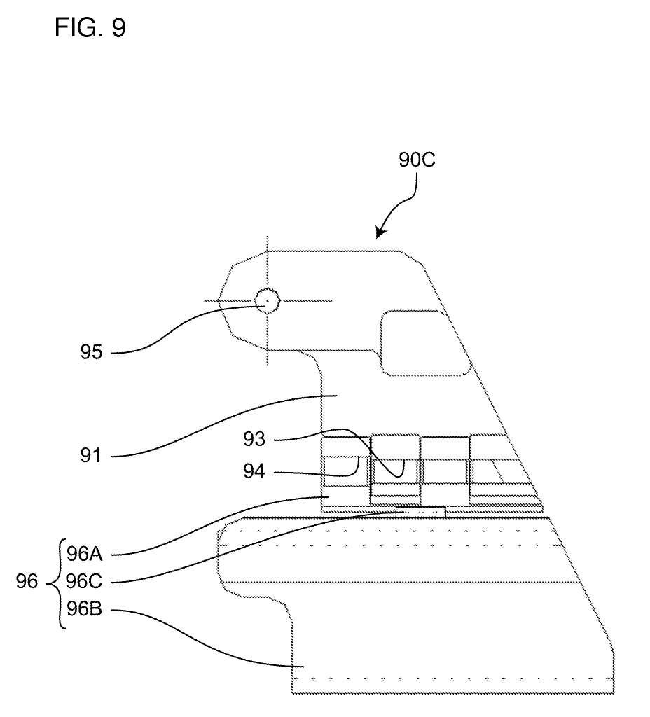

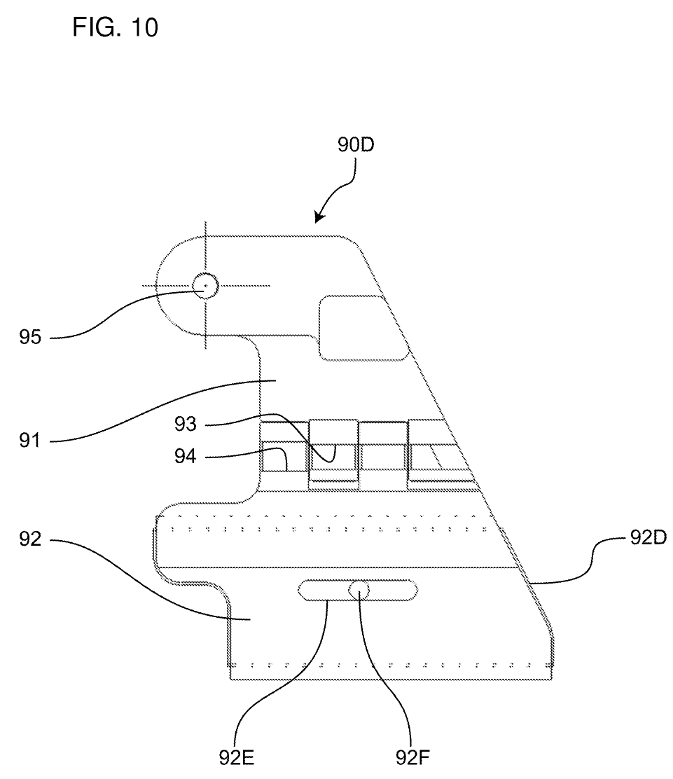

FIG. 9 is a side view of a protecting member according to another embodiment of the invention. FIG. 10 is a side view of a protecting member according to another embodiment of the invention.

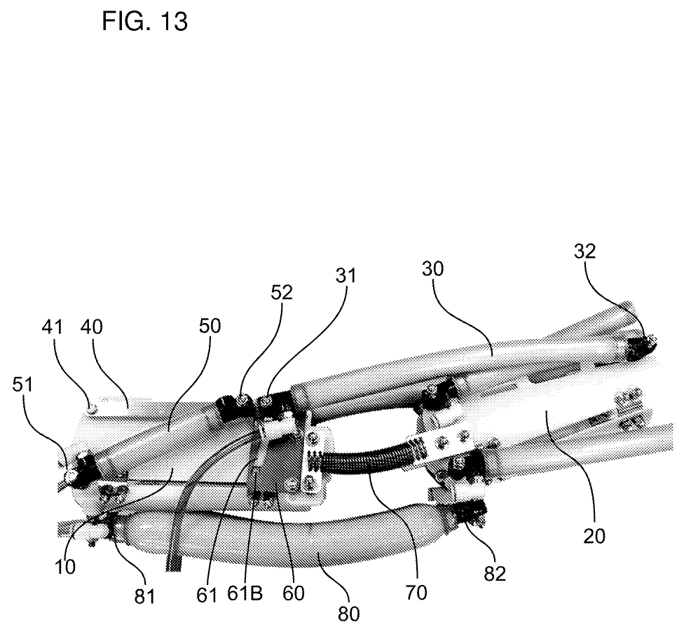

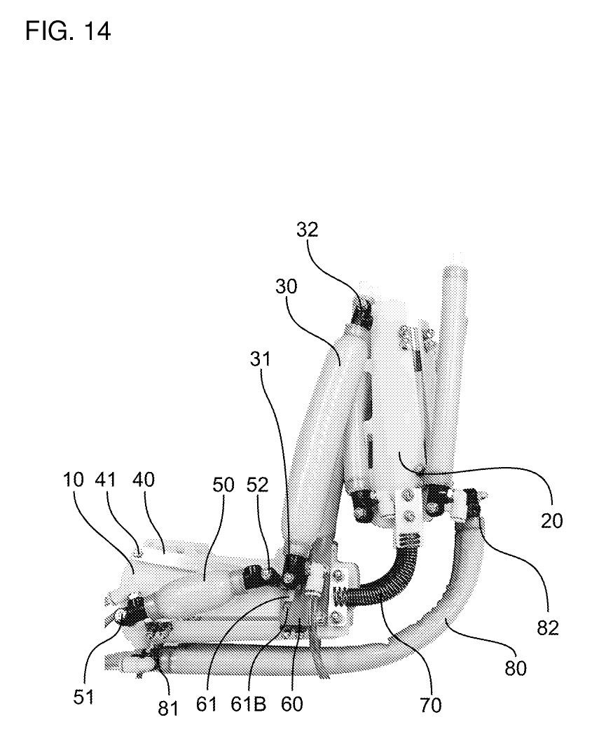

A configuration for assisting bending motion and stretching motion is predicated on the configuration shown in FIGS. 13 and 14. In this embodiment, explanation concerning members that are required for bending motion is omitted.

As shown in FIGS. 1 to 3, the muscle force assisting device according to the embodiment includes a first attachment 10 arranged along one bone of a joint, a second attachment 20 arranged along the other bone of the joint, and a stretching-artificial muscle 80 having one end 81 provided on the first attachment 10, and having the other end 82 provided on the second attachment 20.

When the artificial muscle is attached to an elbow as in this embodiment, the first attachment 10 is attached to an upper arm, and the second attachment 20 is attached to a forearm. The stretching-artificial muscle 80 is arranged outside of the elbow. As shown in FIG. 3, it is preferable that two stretching-artificial muscles 80A and 80B are arranged in parallel to each other.

The stretching-artificial muscle 80 is an actuator that is extensible at least in its longitudinal direction by supplying or discharging a substance such as gas, liquid and solid, or a mixture thereof. The muscle force assisting device includes a power source (not shown) for contracting the stretching-artificial muscle 80.

The first attachment 10 and the second attachment 20 are connected to each other through spring joints 70. Coil springs are used as the spring joints 70. A length of each of the coil springs is adjusted such that a deviation of a rotation shaft of the spring joint 70 caused by the coil spring becomes equal to a deviation of a turning axis of the joint.

The other end 82 of the stretching-artificial muscle 80 is provided on the second attachment 20 through a guide mechanism 83. The guide mechanism 83 includes a fixing member 84 that forms a guide groove, and a movable member 85 that moves along the guide groove. The fixing member 84 is fixed to the second attachment 20, and the movable member 85 holds the other end 82. By moving the other end 82 of the stretching-artificial muscle 80 along the guide mechanism 83 in this manner, it is possible to prevent an unnecessary restricting force of the stretching-artificial muscle 80 at no load from being generated.

It is preferable that an elastic member is provided on the movable member 85 to bias the stretching-artificial muscle 80 in its stretching direction. By biasing the other end 82 of the stretching-artificial muscle 80 by the elastic member in its stretching direction in this manner, it is possible to avoid a case where mechanical friction is generated and an unnecessary restricting force of the stretching-artificial muscle 80 at no load is generated.

The first attachment 10 includes a protecting member 90 as a path-restricting section that restricts a path of the stretching-artificial muscle 80. This protecting member 90 restrains the stretching-artificial muscle 80 from approaching the joint.

FIGS. 4 to 6 show the protecting member 90.

The protecting member 90 the path-restricting section includes a supporting member 91 that is mounted on the first attachment 10, and a holding member 92 that holds the stretching-artificial muscle 80.

The supporting member 91 includes a one-side supporting piece 91A that is provided on one side of the first attachment 10, and an other-side supporting piece 91B that is provided on the other side of the first attachment 10. Since the supporting member 91 includes the one-side supporting piece 91A that is provided on the one side of the first attachment 10 and the other-side supporting piece 91B that is provided on the other side of the first attachment 10 in this manner, the supporting member 91 is supported on both sides of the first attachment 10 and therefore, it is possible to secure stable motion.

The holding member 92 includes a one-artificial muscle holding piece 92A that holds the one stretching-artificial muscles 80A, and an other-artificial muscle holding piece 92B that holds the other stretching-artificial muscle 80B. The two stretching-artificial muscles 80A and 80B that are in parallel to each other are arranged, and the holding member 92 includes the one-artificial muscle holding piece 92A that holds the one stretching-artificial muscle 80A, and the other-artificial muscle holding piece 92B that holds the other stretching-artificial muscle 80B in this manner. With this, bending and stretching motion having small torsion can be carried out.

The one-artificial muscle holding piece 92A is provided on the one-side supporting piece 91A, and the other-artificial muscle holding piece 92B is provided on the other-side supporting piece 91B.

Pin holes 93A and 93B are formed in the supporting member 91, and pin holes 94A and 94B are formed in the holding member 92. A connection pin (not shown) is inserted into the pin hole 93A of the supporting member 91 and into the pin hole 94A of the holding member 92, and a connection pin is inserted into the pin hole 93B of the supporting member 91 and into the pin hole 94B of the holding member 92, whereby the supporting member 91 and the holding member 92 are connected to each other.

In this embodiment, the pin holes 94A and 94B of the holding member 92 are long holes. The pin holes 93A and 93B of the supporting member 91 may be long holes instead of the pinholes 94A and 94B of the holding member 92. If the pin holes 93A and 93B of the supporting member 91, or the pin holes 94A and 94B of the holding member 92 are long holes, it is possible to moderate a load generated by a difference of a physical type of a user or by an attaching deviation, and it is possible to prevent the protecting member from being damaged.

The protecting member 90 is turnably provided on the first attachment 10 through holes 95A and 95B formed in the supporting member 91. By providing the protecting member 90 such that it can turn a predetermined angle with respect to the first attachment 10, it is possible to prevent a change of the path of the stretching-artificial muscle 80 from being excessively restricted.

The protecting member 90 is constituted such that even if the bending or stretching motion is carried out, the path of the stretching-artificial muscle 80 does not interfere with the joint. However, if the protecting member 90 is fixed to the first attachment 10, when the bending angle is increased, the stretching-artificial muscle 80 and the protecting member 90 abut against each other at an acute angle therebetween, and a load is increased. Therefore, the protecting member 90 is constituted such that it can turn with respect to the first attachment 10, the protecting member 90 is turned to a position close to a tangent direction of the joint at the time of the bending motion so that a load generated between the stretching-artificial muscle 80 and the protecting member 90 is reduced. In this case, not only the stretching-artificial muscle 80, but also the protecting member 90 does not interfere with the joint by the bending motion.

The path of the stretching-artificial muscle 80 is restricted by the protecting member 90 such that the path is maintained at a location outside the joint even if the bending motion or stretching motion is carried out. When the restriction of the path of the stretching-artificial muscle 80 is insufficient, the stretching-artificial muscle 80 escapes toward the side surface of the joint, and it is located in the vicinity of or inside of the joint. In such a case, even if the stretching-artificial muscle 80 is driven, its force can not be converted into a stretching torque, the stretching-artificial muscle 80 presses the joint or a load in an unnatural or improper direction is generated, and these factors may cause injury.

In this embodiment, the supporting member 91 sandwiches the spring joints 70 from upper and below to form a groove, whereby spring path-restricting sections 91C and 91D are provided. With this, as each of the spring joints 70 is deformed by the bending or stretching motion, the supporting member 91 follows the deformation and turns and this restricts the path for a load from the stretching-artificial muscle 80 and receives the load.

In addition, it is also possible to turn or restrict the protecting member 90 by a link mechanism or a biasing force using an elastic body.

FIGS. 7 and 8 show a protecting member 90B according to another embodiment. The same function members as those of the previous embodiment are designated with the same symbols, and explanation thereof will be omitted.

According to the protecting member 90B of the embodiment, the spring path-restricting sections 91C and 91D are formed from cylindrical members, and the spring joints 70 are disposed in cavities of the spring path-restricting sections 91C and 91D. If the spring path-restricting sections 91C and 91D are formed from the cylindrical members and the spring joints 70 are disposed in the cavities of the spring path-restricting sections 91C and 91D in this manner, it is possible to more reliably restrict the locations of the spring joints 70 as compared with a case where the spring joints 70 are restricted by the grooves as in the previous embodiment.

Although the one-artificial muscle holding piece 92A and the other-artificial muscle holding piece 92B are connected to each other in the above embodiment, the one-artificial muscle holding piece 92A and the other-artificial muscle holding piece 92B may be separated from each other.

Especially when the first attachment 10 is separated into a one-side first attachment and an other-side first attachment and the second attachment 20 is separated into a one-side second attachment and an other-side second attachment, a user can easily wear the artificial muscle by separating the one-artificial muscle holding piece 92A and the other-artificial muscle holding piece 92B from each other.

Next, protecting members of other embodiments of the invention will be described.

According to each of protecting members shown in FIGS. 9 and 10, the supporting member 91 and the holding member 92 are provided such that they can slide in a longitudinal direction of the stretching-artificial muscle 80. The same members are designated with the same symbols, and explanation thereof will be omitted.

According to the protecting member 90C shown in FIG. 9, a holding member 96 is divided into a first holding piece 96A constituting a connection with respect to the supporting member 91, and a second holding piece 96B that holds the stretching-artificial muscle 80. The second holding piece 96B can slide with respect to the first holding piece 96A, and the first holding piece 96A and the second holding piece 96B are connected to each other through a slider 96C.

According to the protecting member 90D shown in FIG. 10, the holding member 92 is provided with an inner sleeve 92D, and the inner sleeve 92D holds the stretching-artificial muscle 80. The inner sleeve 92D can slide with respect to the holding member 92. A long groove 92E is formed in the holding member 92, a guide pin 92F formed on the inner sleeve 92D is disposed in the long groove 92E, whereby a sliding range of the inner sleeve 92D is restricted.

By providing the supporting member 91 and the holding member 92 such that they can slide in the longitudinal direction of the stretching-artificial muscle 80 in this manner, it is possible to moderate a rub between the protecting member 90 and the stretching-artificial muscle 80 caused by stretch and contraction of the stretching-artificial muscle 80.

According to the muscle force assisting device of the embodiment, the first attachment 10 includes the protecting member 90 that restricts the path of the stretching-artificial muscle 80 as described above. Approaching motion of the stretching-artificial muscle 80 with respect to the joint is restricted by the protecting member 90 in this manner, even if the path of the stretching-artificial muscle 80 is changed by the bending or stretching motion, it is possible to prevent the artificial muscle from pressing a human body, and to efficiently convert a driving force of the stretching-artificial muscle 80 into a stretching torque.

When only the stretching motion is to be assisted, members for bending the artificial muscle shown in FIGS. 13 and 14 need not be provided.

Although the stretching-artificial muscle has been described in the embodiment, the invention can also be applied to a bending-artificial muscle.

Another embodiment of the muscle force assisting device of the invention will be described below.

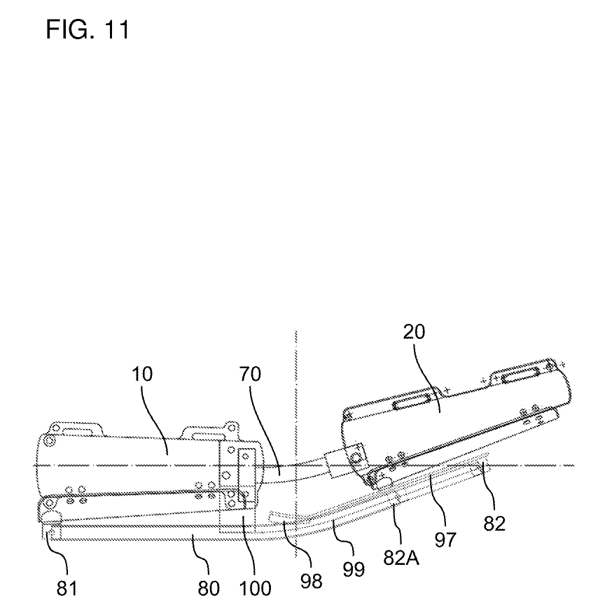

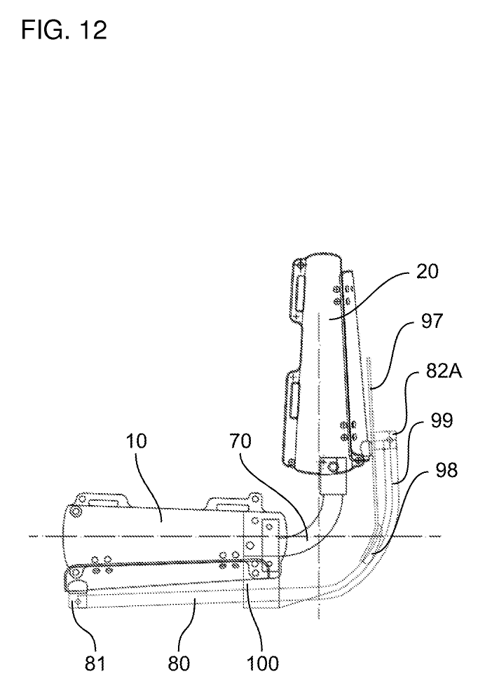

FIG. 11 is a side view showing a stretched state of a muscle force assisting device according to another embodiment of the invention. FIG. 12 is a side view showing a bent state of the muscle force assisting device.

A configuration for assisting bending motion and stretching motion is predicated on the configuration shown in FIGS. 13 and 14, but in this embodiment, explanation concerning members that are required for bending motion is omitted.

As shown in FIGS. 11 and 12, the muscle force assisting device of the embodiment includes the first attachment 10 arranged along one bone of the joint, the second attachment 20 arranged along the other bone of the joint, and the stretching-artificial muscle 80 having one end 81 provided on the first attachment 10, and having the other end 82 provided on the second attachment 20.

When the muscle force assisting device is attached to the elbow as in this embodiment, the first attachment 10 is attached to the upper arm and the second attachment 20 is attached to the forearm. The stretching-artificial muscle 80 is located outside of the elbow. It is preferable that two stretching-artificial muscles (not shown) that are in parallel to each other are disposed.

Each of the artificial muscles 80 is an actuator that is extensible at least in its longitudinal direction by supplying or discharging a substance such as gas, liquid and solid, or a mixture thereof. The muscle force assisting device includes a power source (not shown) for contracting the stretching-artificial muscle 80.

The first attachment 10 and the second attachment 20 are connected to each other through spring joints 70. Coil springs are used as the spring joints 70. A length of the coil spring is adjusted such that a deviation of a rotation shaft of the spring joint 70 caused by the coil spring becomes equal to a deviation of a turning axis of the joint.

The other end 82 of the stretching-artificial muscle 80 is provided on the second attachment 20 through a guide 97. The guide 97 is arranged along the forearm, i.e., along the other bone. A path-restricting section 98 that restricts the path of the stretching-artificial muscle 80 is provided on the end of the guide 97 on the side of the joint.

The other end 82 of the stretching-artificial muscle 80 is provided such that the other end 82 can slide within a predetermined range with respect to the guide 97. In FIGS. 11 and 12, the other end 82A is located in such a position that the stretching-artificial muscle 80 is driven and the other end 82 is slid toward the joint. That is, the other end 82 can slide to the position of the other end 82A.

One end of a wire that is a tension-giving member 99 is mounted on the other end 82 of the stretching-artificial muscle 80, and the other end of the wire is mounted on the first attachment 10 through a tension generator 100.

The path-restricting section 98 also restricts a path of the wire that is the tension-giving member 99.

According to the muscle force assisting device of the invention, as described above, the guide 97 is provided on the second attachment 20 that is attached to the forearm, and the path-restricting section 98 that restricts the path of the stretching-artificial muscle 80 is provided on the end of the guide 97 on the side of the joint. As described above, even when the elbow is bent, the path-restricting section 98 is disposed such that a straight line connecting a terminal end of the path-restricting section 98 and a fixed end of the first attachment 10 of the stretching-artificial muscle 80 is always located outside of the joint. With this, even if the stretching-artificial muscle 80 is contracted at a position where the bending angle is deep, it is possible to prevent the artificial muscle from pressing a user, and to efficiently convert the driving force of the stretching-artificial muscle 80 into a stretching torque.

The location outside of the joint is a location where the artificial muscle does not interfere with the joint. Although the path-restricting section 98 is disposed outside of the joint in the embodiment, the path-restricting sections 98 may be disposed on both sides of the joint.

At that time, it is necessary that the stretching-artificial muscle 80 has a sufficient length so that the stretching-artificial muscle 80 does not interfere with a user or the attachment when the elbow is bent. Hence, the muscle force assisting device is designed such that the other end 82 of the stretching-artificial muscle 80 can slide. With this, the length required when bending the elbow can be secured, and large sag that may be generated when the artificial muscle is stretched with a natural length can be prevented.

Although the other end 82 of the stretching-artificial muscle 80 can slide in the embodiment, the one end 81 may slide instead of the other end 82.

Although the path-restricting section 98 that restricts the stretching-artificial muscle 80 is provided on the second attachment 20 in this embodiment, the path-restricting section 98 may be provided from the first attachment 10 that is a fixed end of the stretching-artificial muscle 80 toward a free end of the stretching-artificial muscle 80. With this configuration, a rub between the stretching-artificial muscle 80 and other member caused when the stretching-artificial muscle 80 is bent with a natural length can be prevented, and hindrance to bending motion of the stretching-artificial muscle 80 can be prevented.

A distance (path) between the free end and the fixed end of the stretching-artificial muscle 80 is restricted by the tension-giving member 99. With this restriction, the free end of the forearm moves toward the joint, it is possible to prevent the stretching-artificial muscle 80 from interfering with a plate of the second attachment 20 or the guide. Although the wire is used as the tension-giving member 99 in this embodiment, a leaf spring may be used, and it is only necessary that a sufficient tension that can move the free end toward the joint can be provided.

When only the stretching motion is to be assisted, members for bending the artificial muscle shown in FIGS. 13 and 14 need not be provided.

Although the stretching-artificial muscle has been described in the embodiment, the invention can also be applied to a bending-artificial muscle.

The present invention can be utilized as a muscle force assisting device that assists motion of a joint such as an elbow, a knee and a wrist.

What is claimed is:

1. A muscle force assisting device comprising
a first attachment arranged along one bone of a joint,
a second attachment arranged along the other bone of the joint, and
an artificial muscle having one end provided on the first attachment and having the other end provided on the second attachment, in which
an actuator that is extensible by supplying or discharging a substance such as gas, liquid and solid, or a mixture thereof is used as the artificial muscle, and
the muscle force assisting device assists motion of a user's joint such as an elbow, a knee and a wrist, wherein
a path-restricting section that restricts a path of the artificial muscle is provided on the first attachment or the second attachment.

2. The muscle force assisting device according to claim 1, wherein the path-restricting section is provided on the first attachment, and the path-restricting section restricts approach of the artificial muscle toward the joint.

3. The muscle force assisting device according to claim 2, wherein the path-restricting section is provided on the first attachment such that the path-restricting section can turn.

4. The muscle force assisting device according to claim 2, wherein the path-restricting section includes a supporting member mounted on the first attachment, and a holding member that holds the artificial muscle, a pin hole of the supporting member and a pin hole of the holding member are connected to each other through a connection pin, and the pin hole of one of the supporting member or the holding member is a long hole.

5. The muscle force assisting device according to claim 2, wherein the path-restricting section includes a supporting member mounted on the first attachment, and a holding member that holds the artificial muscle, and the supporting member and the holding member can slide in a longitudinal direction of the artificial muscle.

6. The muscle force assisting device according to claim 4 or 5, wherein the supporting member includes a one-side supporting piece provided on one side of the first attachment, and an other-side supporting piece provided on the other side of the first attachment.

7. The muscle force assisting device according to claim 6, wherein the two artificial muscles are arranged in parallel to each other, the holding member includes a one-artificial muscle holding piece that holds one artificial muscle and an other-artificial muscle holding piece that holds the other artificial muscle, the one-artificial muscle holding piece is provided on the one-side supporting piece, and the other-artificial muscle holding piece is provided on the other-side supporting piece.

8. The muscle force assisting device according to claim 7, wherein the first attachment is separated into a one-side first attachment and an other-side first attachment, the second attachment is separated into a one-side second attachment and an other-side second attachment, and the one-artificial muscle holding piece and the other-artificial muscle holding piece are separated from each other.

9. The muscle force assisting device according to claim 2, wherein the other end of the artificial muscle is provided on the second attachment through a guide mechanism, and the other end of the artificial muscle moves along the guide mechanism.

10. The muscle force assisting device according to claim 9, wherein the other end of the artificial muscle is biased by an elastic member in a stretching direction of the artificial muscle.

11. The muscle force assisting device according to claim 2, wherein the first attachment is attached to an upper arm, the second attachment is attached to a forearm, and the artificial muscle is located outside of the elbow.

12. The muscle force assisting device according to claim 1, wherein a guide is provided on the second attachment along the other bone, and the path-restricting section is provided on an end of the guide on the side of the joint.

13. The muscle force assisting device according to claim 12, wherein a straight line connecting a terminal end of the path-restricting section and a fixed end of the first attachment of the artificial muscle is always located outside of the joint.

14. The muscle force assisting device according to claim 12, wherein the other end of the artificial muscle is provided on the guide such that the other end can slide.

15. The muscle force assisting device according to claim 12, further comprising a tension-giving member that pulls the other end of the artificial muscle toward the one end thereof.

16. The muscle force assisting device according to claim 15, wherein a wire is provided as the tension-giving member, one end of the wire is mounted on the other end of the artificial muscle, and the other end of the wire is mounted on the first attachment.

17. The muscle force assisting device according to claim 16, wherein a path of the wire is restricted by the path-restricting section.

18. The muscle force assisting device according to claim 12, wherein the first attachment is attached to an upper arm, the second attachment is attached to a forearm, and the artificial muscle is located outside of the elbow.
